(19) United States
(12) Patent Application Publication
(10) Pub. No.: US 2006/0253899 A1
(43) Pub. Date: Nov. 9, 2006

(54) Expansion connector

(76) Inventor: Kowk-Yan Leung, Willowdale (CA)

Correspondence Address: LIN & ASSOCIATES INTELLECTUAL PROPERTY, P.O. BOX 2339, SARATOGA, CA, 95070-0339, US

(21) Appl. No.: 11/121,256

(22) Filed: May 3, 2005

(51) Int. Cl. G06F 15/16

(52) U.S. Cl. 726/11

(57) ABSTRACT

An expansion connector is provided. The expansion connector on a network access circuit board is posed in between the network connection port and the network controller, where the first connector pins are electrically connected to corresponding pins of the network connection port responsible which are responsible for sending/receiving network packets, and the second connector pins are electrically connected to corresponding pins of the network controller which are responsible for inspection of network packets. A firewall unit can be selectively installed on the integrated motherboard or network adaptor as needed, so that the system configuration can be rationalized, and the production costs for the circuit boards can thus be reduced.

### BACKGROUND OF THE INVENTION

1. Field of the Invention

The present invention relates to an expansion connector, and in particular to an expansion connector installable between the network connection port and the network controller.

2. The Related Art

The wide spread use of internet connection and wireless LANs accelerates the propagation of viruses and worms to homes and businesses alike, which have devastated their computer systems and network devices. To counter this wave of network crimes, network engineers proposed different firewall technologies to prevent the hostile intruders from breaking in.

Until quite recently, on-chip firewall is still the most effective protection for network users, which employs a dedicated firewall chip on the integrated mother board or network adaptor, through which any potential intruders trying to sneak into the user computer through the network connection can be correctly identified and filtered out.

However, if the firewall function is to be a standard feature in all network adaptors and integrated mother boards, the production costs of network adaptors and integrated mother boards will definitely increase, because of an additional chip for the firewall, and yet some computer users may not need the firewall at all.

The design of the network adaptors and integrated mother boards shall allow a user to decide whether or not the firewall protection is a priority item when the user plans to install a network adaptor or integrated mother board.

In other extreme case, if the network adaptor and the integrated mother board that the user purchased both have the firewall on board, one of them will be made redundant. If the new computer system is not carefully tuned in the set up process, this situation could also give rise to signal conflicts in the computer operation.

To overcome the above-mentioned problems, the present invention intends to provide an expansion connector that enables the user to selectively install the firewall unit on the network adaptors and integrated motherboards. In any case, the firewall technology is expected to be the trend for the future.

### SUMMARY OF THE INVENTION

The primary object of the present invention is to provide an expansion connector on a circuit board, posed between the network connection port and the network controller, which enables the user to selectively add on a firewall unit as needed, so that the designs for the mother boards and network adaptors can be rationalized.

The present invention is to achieve the above object by creating an expansion connector on the circuit board posed between the network connection port and network controller, wherein the expansion connector is composed of two sets of connector pins, where the first connector pins are electrically connected to corresponding pins of the network connection port which are responsible for sending/receiving network packets, and the second connector pins are electrically connected to corresponding pins of the network controller which are responsible for inspection of the network packets.

The present invention offers a flexible design to meet the needs of the end users, who may use the expansion connector to selectively install a firewall unit.

To create the firewall in networking, a flat ribbon cable is connected across an optional firewall unit and the expansion connector, so that network packets are then routed from the circuit board to the firewall unit through the first connection pins, and after inspection of network packets the packets are returned to the circuit board through the second connector pins.

If the user decides not to use the firewall, a pass-through connector can be inserted into the expansion connector, so that the network access circuit board is still able to function as a regular network adaptor or mother board, still having the networking ability but without the firewall.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is an isometric view of a network access circuit board having the expansion connector on board;

FIG. 2 is an isometric view of a circuit board having integrated network connection port; and

FIGS. 3A and 3B are block diagrams of two embodiments of the present invention having the firewall unit.

### DETAILED DESCRIPTION OF THE PREFERRED EMBODIMENT

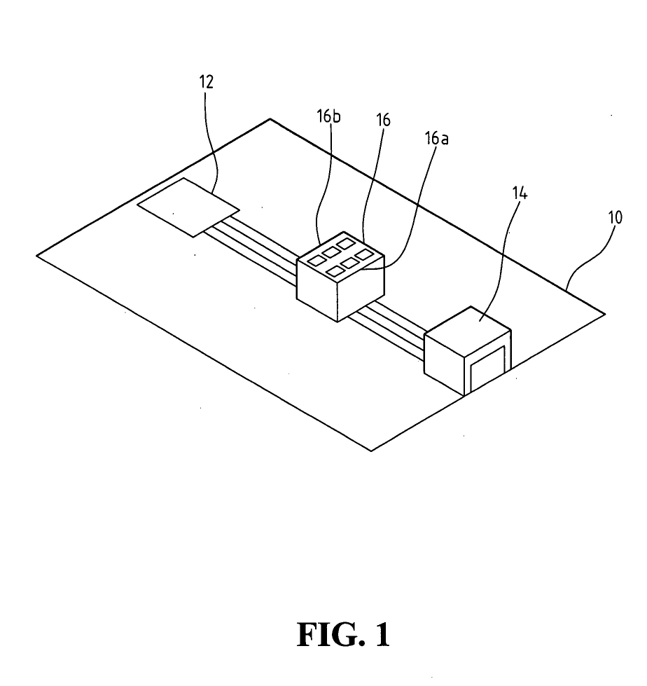

Referring to FIG. 1, the expansion connector 16 in accordance with present invention is installable on a network access circuit board 10, posed in between a network connection port 14 and a network controller 12. The expansion connector 16 is composed of two sets of connector pins 16a, 16b, wherein the first connector pins 16a are electrically connected to corresponding pins of the network connection port 14, and the second connector pins 16b are electrically connected to corresponding pins of the network controller 12.

The first connector pins 16a of the expansion connector 16 are electrically connected to corresponding pins of the network connection port 14 responsible for sending/receiving network packets, and the second connector pins 16b are electrically connected to corresponding pins of the network controller 12 responsible for inspection of network packets.

The main advantage of the present invention is that the network access circuit board does not have to be changed shall the user decide to add the firewall protection after a certain time.

Normally, when a password is entered into a computer, a network packet is generated and passed to the network controller 12, and then the network packet is immediately sent out through the network connection port 14. But in the present case, the network access circuit board 10 has an expansion connector 16 posed between a network controller 12 and a network connection port 14 as shown in FIG. 1, which means the circuit between the network connection port 14 and network controller 12 is intercepted by the expansion connector 16.

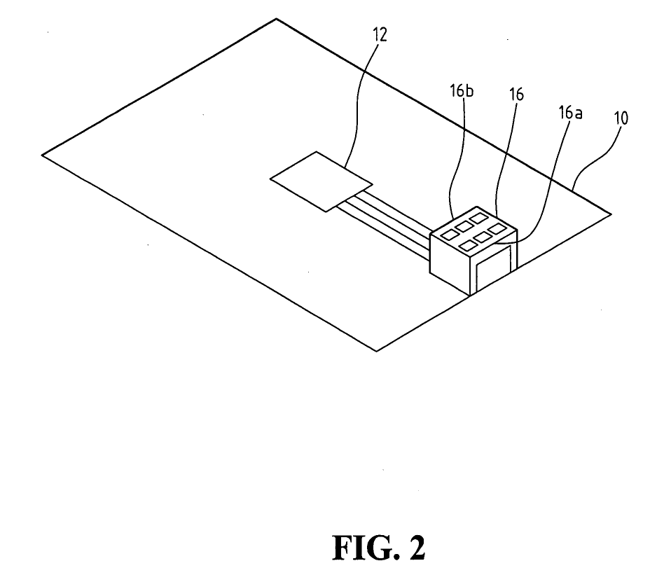

Referring to FIG. 2, for an integrated mother board or network adaptor having an integrated network connection port 60 on board, which basically has an expansion connector 16 and a conventional network connection port 14, the user is given the flexibility to establish network access either with firewall protection or without. The firewall is considered as add-on to the standard circuit board functions.

If the user decides to use the firewall protection in networking, a firewall unit (not shown) can be separately added, and a flat ribbon cable (not shown) is connected between the firewall unit and the expansion connector 16 on the network access circuit board 10, so that network packets are first routed to the firewall unit for inspection of network packets before further processing by the computer.

If the user decides not to use the firewall in networking, a pass-through connector (not shown) can be inserted into the expansion connector 16, so that the network access circuit board 10 is still able to function as a regular network adaptor or motherboard, only without the firewall protection.

In such manner, the user can selectively install a firewall unit on the motherboard or network adaptor as needed. The computer system can be configured with more flexibility, and the costs of the integrated motherboards and network adaptors can thus be reduced.

Two implementations of the present invention are respectively illustrated below.

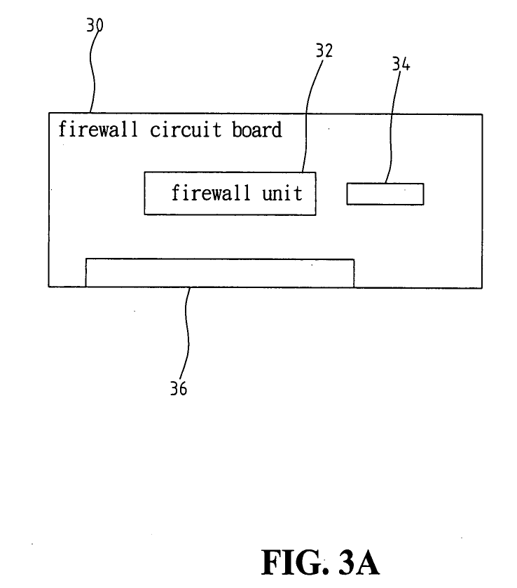

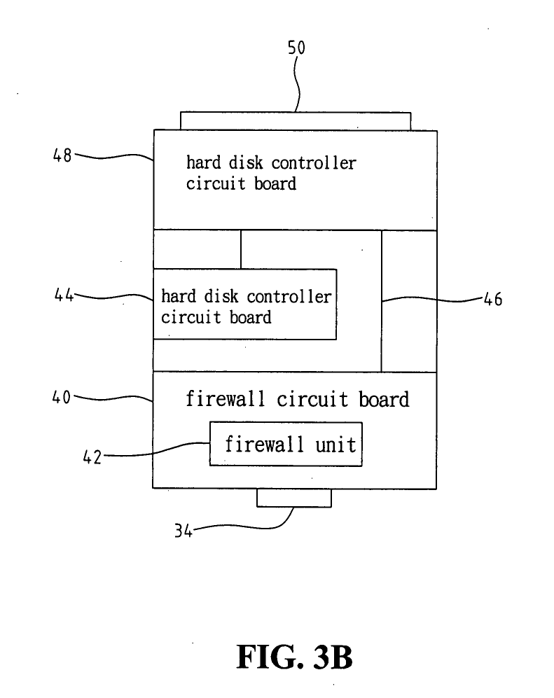

Referring to FIG. 3A, the firewall circuit board 30 contains a firewall unit 32 and a firewall connector 34. When the firewall unit 32 is connected to the expansion connector 16 by a flat ribbon cable (not shown), and on-line connection is established, network packets are routed to the firewall unit 32, and after the inspection, the filtered packets are returned to the network access circuit board 10.

If the firewall circuit board 30 also has a PCI interface 36 in addition to the firewall unit 32, the firewall circuit board 30 can be connected to the PCI slot (not shown) through the PCI interface 36, so that the main processor in the computer is able to manipulate the firewall unit 32 through the PCI interface.

Referring to FIG. 3B, the firewall circuit board 40 is integrated with hard disk circuit board assembly, where the firewall circuit board 40 is formed by a firewall unit 42 and a firewall connector 34, and the hard disk circuit board assembly is composed of two hard disk controllers 44, 48, an internal bus 46, and a peripheral interface 50. When the firewall unit 42 is connected to the expansion connector 16 by a flat ribbon cable (not shown), and on-line connection is established, network packets are routed through the firewall connector 34 to the firewall unit 42. In this manner, the computer is able to manipulate the firewall unit 42 through the peripheral interface 50.

The above-mentioned peripheral interface 50 can be a small computer system interface (CSCI), integrated drive electronics (IDE), universal serial bus (USB), a serial advanced technology attachment (serial ATA), or parallel ATA, or appropriate bus interface.

An example of the actual operation of the firewall unit 42 is illustrated below using the hardware configuration shown in FIG. 3B. In this case, after a password is entered by a network user, that user information is routed to the firewall unit 42 on the firewall circuit board 40. At the same time, an authentication request is issued by the main processor (not shown) through the peripheral interface 50 of the hard disk control board to order the firewall unit 42 to validate the user who may try to log in. The user information is thus compared with the existing records stored in domain name data base (not shown) over the network, and the result is returned to the network access circuit board.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An expansion connector for installation between a network connection port and a network controller, comprising:
first connector pins electrically connected to corresponding pins of the network connection port which are responsible for sending/receiving network packets; and
second connector pins to be electrically connected to corresponding pins of the network controller which are responsible for inspection of network packets.

2. The expansion connector as claimed in claim 1, wherein the expansion connector is connected to a firewall unit by a flat ribbon cable, whereby network packets are routed to the firewall unit for inspection of network packets, and then the filtered packets are returned to the network access circuit board.

3. The expansion connector as claimed in claim 2, wherein the firewall unit is installed on a firewall circuit board, and connected to the expansion connector on the network access circuit board through a firewall connector.

4. The expansion connector as claimed in claim 3, wherein the firewall circuit board, when equipped with PCI interface, is inserted into a PCI slot to allow the main processor to manipulate the firewall unit through the PCI interface.

5. The expansion connector as claimed in claim 3, wherein the firewall circuit board, when integrated with a hard disk circuit board, is connected to internal bus of the hard disk circuit board to allow the main processor to manipulate the firewall unit through the peripheral interface.

6. The expansion connector as claimed in claim 5, wherein the peripheral interface is a small computer system interface (CSCI), integrated drive electronics (IDE), universal serial bus (USB), a serial advanced technology attachment (serial ATA), or parallel ATA, or other appropriate bus interface.

7. The expansion connector as claimed in claim 1, wherein the expansion connector is installed on a network adaptor or integrated motherboard having the network connection port and network controller on board.

8. The expansion connector as claimed in claim 1, wherein the expansion connector is incorporated into an integrated network connection port to replace the conventional network connection port.

9. The expansion connector as claimed in claim 1, wherein the expansion connector further includes a pass-through connector which is used to short circuit corresponding first and second connector pins, so that the first connector pins associated with the network connection port and the second connector pins associated with the network controller are interconnected.
